(19) United States
(12) Patent Application Publication
(10) Pub. No.: US 2008/0110308 A1
(43) Pub. Date: May 15, 2008

(54) PUNCH WORKING APPARATUS AND METHOD

(75) Inventors: Yoshihiro Iwashita, Shizuoka (JP); Tetsuya Suzuki, Shizuoka (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA F.C.C, Shizuoka (JP)

(21) Appl. No.: 11/938,201

(22) Filed: Nov. 9, 2007

(30) Foreign Application Priority Data
Nov. 9, 2006 (JP) 2006-303494

(51) Int. Cl. B26F 1/02; B26D 7/18; B26D 7/00

(52) U.S. Cl. 83/13; 83/618

(57) ABSTRACT

Embodiment, punch working apparatus has a first mold frame on which a die is mounted, a second mold frame movable toward and away from the first mold frame and a punch mounted on the first mold frame for simultaneously performing both outer and inner circumferential punching works on a sheet material between the frames, the punch containing resulted scraps in a space defined therewithin. A sub-punch is also provided, and punches an aperture having a predetermined configuration at a position of the sheet material that ends up as part of the scrap formed by and contained within the punch.

### CROSS-REFERENCE TO RELATED APPLICATIONS

The present application is based on and claims priority under 35 U.S.C. § 119 to Japanese Patent Application Serial No. 2006-303494, filed on Nov. 9, 2006, the entire contents of which are expressly incorporated by reference herein.

### BACKGROUND

1. Field of the Invention

The present invention relates to a punch working apparatus and method for performing both outer and inner circumferential punching works on a sheet material.

2. Description of the Related Art

Japanese Laid-open Patent Publication No. 2006-239711 discloses an example of a punching apparatus having so-called “compound dies” in which both outer and inner circumferential punching works are simultaneously performed. The disclosed apparatus comprises a lower mold frame on which a female shearing mold (die) and an upper mold frame movable toward and away from the lower mold frame. The upper mold frame includes a male shearing mold (punch) for simultaneously performing both the outer and inner circumferential punching workings on a sheet material laid on the die when the upper mold frame approaches proximately to the lower mold frame.

Such a punching apparatus can prevent generation of shear drop and burring at a sheared surface of product and obtain a good sheared surface by setting a very small clearance between the female shearing mold and the male shearing mold.

In some embodiments a plurality of scraps from the inner circumferential punching can be contained within the female shearing mold (punch).

However, since the scraps resulted from the punch working are contained in a containing space of the punch, the punch may sometimes bulge radially outward due to internal stress of the scraps contained in the punch acting radially outwardly against the punch. Accordingly, sometimes a bulged punch interferes with the associated die.

Although it may be possible to set a relatively large clearance between the die and the punch in order to solve this problem, shear drop or burring would be caused in the sheared surface and thus a good sheared surface cannot be formed.

### SUMMARY

Accordingly, there is a need in the art for a punch working apparatus that can avoid interference between the die and the punch and thus obtain a good sheared surface of a product.

In one embodiment, a punch working apparatus is arranged so that an aperture is formed in a portion of a sheet material and then aligned with a punch during punch work. The aperture is aligned so as to be in a portion of the sheet material that becomes scrap during punch working. However, the aperture benefits the punch working. For example, in an embodiment in which the scrap is received into a space within the punch, the aperture better enables the scrap to be held in the space within the punch without applying pressure to the punch that would bulge the punch walls and cause potential interference with the die.

In accordance with one embodiment, the present invention provides a punch working apparatus comprising a first mold frame on which a die is mounted, a second mold frame movable toward and away from the first mold frame, a punch mounted on the second mold frame, and a sub-punch. The sub-punch is adapted for punching an aperture through a sheet material arranged between the first and second mold frames. The punch is adapted for simultaneously performing both outer and inner circumferential punching works on the sheet material and containing scraps from punching in a space defined in the punch. The sub-punch is aligned with the punch so that, when the sheet material is advanced after a punching work, an aperture punched by the sub-punch is disposed in a portion of the sheet material that becomes scraps contained in the space of the punch upon punching work of the punch so that scraps received in the space of the punch have the aperture formed therein.

In one such embodiment, the punch has a generally cylindrical configuration and comprises an outer punching edge for performing an outer circumferential punching work, an inner punching edge for performing an inner circumferential punching work, and the space for containing therein a plurality of scraps in a stacked manner.

In another embodiment, the sheet material is orderly and intermittently fed from the sub-punch to the punch in regions under them and is simultaneously performed punching works by them when the upper mold frame approaches proximately to the lower mold frame.

A further embodiment additionally comprises a sheet advancement mechanism for advancing the sheet material through the apparatus. The advancement mechanism is adapted to intermittently advance the sheet material so that an aperture formed by the sub-punch is advanced to align with a portion of the punch so that the aperture is included in a scrap created during punching work of the punch and contained within the space of the punch.

In accordance with another embodiment, the present invention provides a method for performing punch working. A punch working apparatus is provided having a first mold frame on which a die is mounted, a second mold frame movable toward and away from the first mold frame, a punch mounted on the second mold frame, and a sub-punch. The method additionally comprises feeding a sheet material between the first and second mold frames, moving the first and second mold frames toward one another so that the punch and sub-punch perform punch working on the sheet material, the sub-punch adapted to form an aperture through the sheet material, the punch adapted to simultaneously perform both outer and inner circumferential punching works on the sheet material, moving the first and second mold frames away from one another, advancing the sheet material so that an aperture punched in the sheet material by the sub-punch is aligned with the punch, and moving the first and second mold frames toward one another so that the punch performs punch working on the sheet material and generates a scrap. The scrap includes the aperture that was aligned with the punch.

In another embodiment, the punch has a space defined therein, and when the punch performs punch working on the sheet material the scrap is received into the space.

In still another embodiment, the punch has a cylindrical configuration and comprises an outer punching edge for performing an outer circumferential punching work, an inner punching edge for performing an inner circumferential punching work, and the space. The space is configured for containing therein a plurality of scraps in a stacked manner.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a schematic cross-section view of one embodiment of a punching apparatus;

FIG. 2 is a plan view of the lower mold frame of the punching apparatus of FIG. 1;

FIG. 3 is an schematic explanatory cross-section view showing punching work performed by the sub-punch of the punching apparatus of FIG. 1;

FIG. 4 is a schematic explanatory view showing the outer and inner circumferential punching works performed by the punch of the punching apparatus of FIG. 1;

FIG. 5 is a schematic view showing a stacked condition of a plurality of scraps contained in the containing space of the punch: and

FIG. 6 is a bottom view of the punch of the punching apparatus of FIG. 1.

### DETAILED DESCRIPTION OF PREFERRED EMBODIMENTS

Embodiments will be hereinafter described with reference to the drawings.

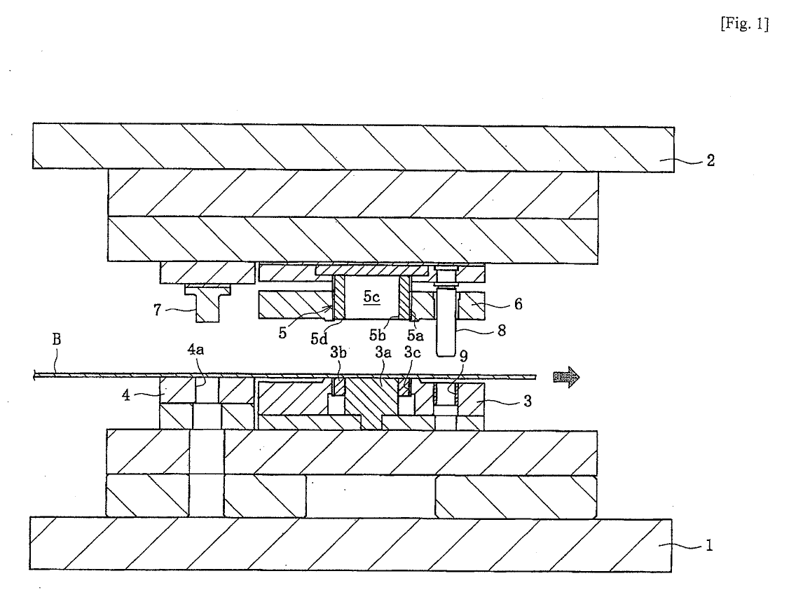

A punch working apparatus in accordance with one preferred embodiment is for manufacturing annular products (e.g. clutch plates of a multiple disc clutch) by punching a metal sheet material “B” and is especially for so-called “compound dies” in which both outer and inner circumferential punching works of the sheet material “B” are simultaneously performed. Such an example punching apparatus comprises as shown in FIG. 1 a lower mold frame 1 on which a die 3 and a sub-die 4, etc. are mounted, and an upper mold frame 2 on which a punch 5 and a sub-punch 7, etc. are mounted.

In a preferred embodiment, the sheet material “B” is a belt-shaped continuous material for example intermittently uncoiled by an uncoiler from a coiled material via a leveler feeder. The sheet material “B” is fed toward the right in FIG. 1 and laid on the sub-die 4 and the die 3 so as to be punched by the sub-die 7 and the punch 5. That is, the sheet material “B” is intermittently fed to both regions under the sub-punch 7 and the punch 5 and then simultaneously punch worked there by the sub-punch 7 and the punch 5.

The illustrated lower mold frame 1 is secured on the press working apparatus and supports on its upper surface the sub-die 4 and the die 3. The illustrated upper mold surface 2 is driven by a driving mechanism (not shown) so that it is moved toward and away from the lower mold frame 1. The sub-punch 7 and punch 5 are mounted on the bottom surface of the upper mold frame 2 respectively at positions oppositely corresponding to the sub-die 4 and die 3 on the lower mold frame 1.

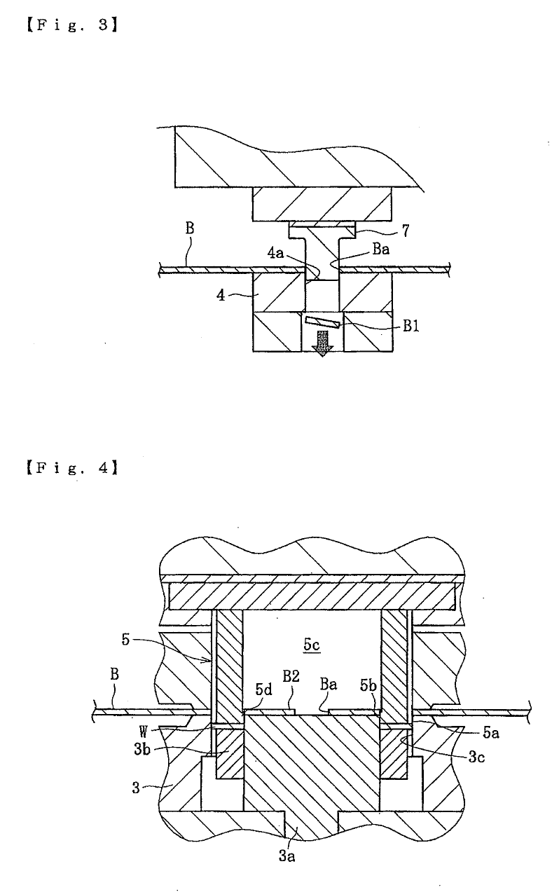

The illustrated sub-die 4 has a substantially circular punching aperture 4a corresponding to the outer circumferential configuration of the sub-punch 7 and the punching work is performed with the sub-punch 7 being inserted in the punching aperture 4a when the upper mold frame 2 approaches proximately to the lower mold frame 1. A reference character “Ba” (see FIGS. 3-6) denotes an aperture formed in the sheet material “B” by the sub-punching work. The position at which the aperture Ba is punched is set at a region corresponding to the scrap B2 formed by the punch 5.

A scrap B1 punched by the sub-punch 7 falls in the punching aperture 4a (see FIG. 3) and the region in which the aperture Ba is formed is fed to the position under the punch 5. The sheet material “B” is intermittently fed with repeating stop of feeding when the upper mold frame 2 has approached proximately to the lower mold frame 1 and re-start of feeding when the upper mold frame 2 has moved away from the lower mold frame 1.

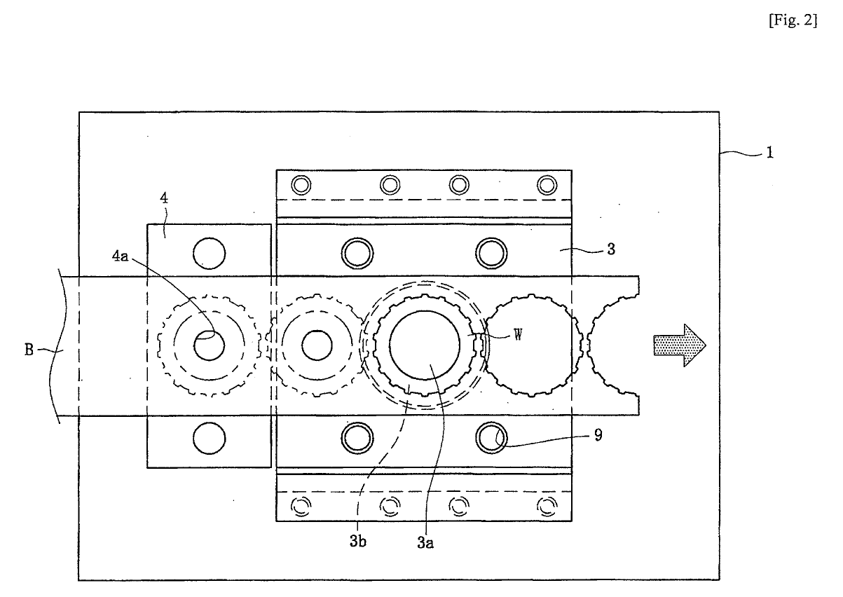

The illustrated die 3 has a central portion 3a and an annular portion 3b arranged vertically movable along the outer circumferential surface of the central portion 3a. An annular opening 3c is formed around the outer circumference of the annular portion 3b. It should be noted that the die 3 including the central portion 3a and the annular portion 3b can shift in the horizontal plane as a unit as will be hereinafter described in detail. The annular portion 3b has outer and inner circumferential profiles corresponding to those of the product (see FIG. 2) and is movable relative to the central portion 3a and the annular opening 3c. The annular portion 3b is returned upward to its original position by a knockout pin (not shown) abutting the bottom surface of the annular portion 3b.

The illustrated punch 5 is substantially cylindrical and has a punching edge 5a for performing an outer circumferential punching work and a punching edge 5b for performing an inner circumferential punching works. The punch 5 can simultaneously perform both outer and inner circumferential punching works and also can contain resulted scraps B2 in a scrap containing space Sc in a stacked manner. A radially inwardly-extending projection 5d preferably is formed on an opened edge leading to the scrap containing space 5c.

The tip end face of the illustrated punch 5 is designed so that it is oppositely faced to the top end face of the annular portion 3b of the die 3 with the sheet material “B” interposing therebetween. As the upper mold frame 2 is moved toward the lower mold frame 1, the annular portion 3b of the die 3 is pushed downward together with the knockout pins (not shown) as shown in FIG. 4 and the sheet material “B” is sheared and punched between the punching edge 5a of the punch 5 and the circumferential edge of the opening 3c as well as between the punching edge 5b of the punch 5 and the outer circumferential edge of the central portion 3a of the die 3.

As just discussed, in this embodiment the outer and inner circumferential punching works can be simultaneously performed by shearing actions respectively between the punching edge 5a of the punch 5 and the circumferential edge of the opening 3c as well as between the punching edge 5b of the punch 5 and the outer circumferential edge of the central portion 3a of the die 3. Accordingly the annular products “W”, such as clutch plates of a multiple disc clutch, can be manufactured with high speed and high accuracy.

In addition, the provision of the projection 5d helps prevent the scraps B2 contained in the containing space 5c from being dropped out therefrom when the upper mold frame 2 ascends relative to the lower mold frame 1.

As best shown in FIG. 1 projected from the upper mold frame 2 are guide bars 8 which are adapted to be inserted into guide bores 9 formed in the die 3 when the upper mold frame 2 approaches toward the lower mold frame 1. In addition a pad 6 made of soft material preferably is arranged around the punch 5. This pad 6 can engage the sheet material “B” when the upper mold frame 2 approaches the lower mold frame 1. However since the pad 6 can move upward and/or compress relative to the upper mold frame 2 when the upper mold frame 2 descends, the pad 6 does not interfere with the punching work.

The annular portion 3b of the die 3 preferably is elevated beyond its initial position by knockout pins (not shown) so that easy removal of the product “W” can be achieved. As can be easily understood the punching work of forming the aperture 4a by the sub-punch 7 and the outer and inner circumferential punching works by the punch 5 are simultaneously performed when the upper mold frame 2 approaches proximally to the lower mold frame 1.

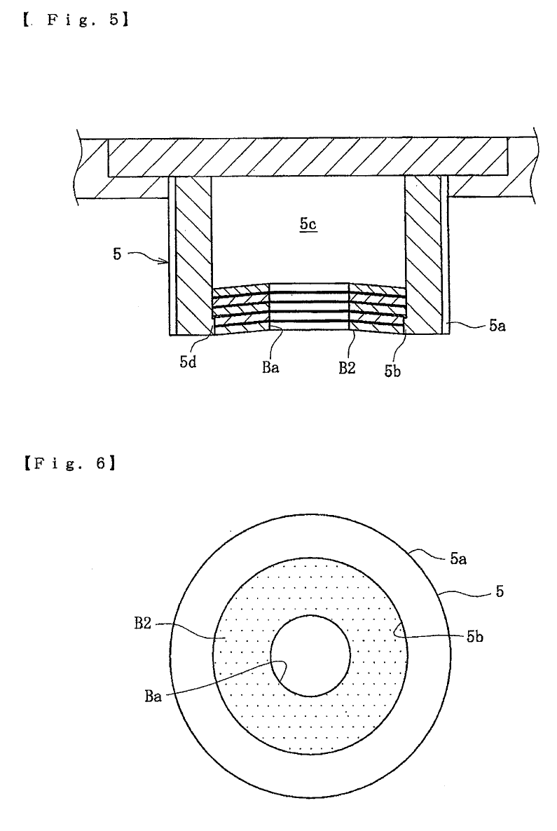

As shown in FIGS. 5 and 6, a plurality of scraps B2 are contained in the containing space 5c of the punch 5 in a stacked manner after repeated punching works. As previously mentioned, the aperture Ba is punched in each scrap B2; the aperture Ba acts to relieve stress caused by the punch 5 when contained in the space 5c radially inward (i.e. toward the aperture Ba). Accordingly the cumulative large stress in the plurality of scraps B2, which could act together to bulge the punch 5 radially outward, can be effectively reduced by the provision of the aperture Ba in each scrap B2.

Thus according to the present embodiment, the deformation (i.e., radially outward bulge) of the punch 5 which would be otherwise caused by the scraps B2 contained in the punch 5 can be avoided and therefore it is possible to keep good sheared surfaces in the products “W” and also to avoid interference between the punch 5 and die 3. That is, according to the present embodiments, since the deformation of the punch 5 which would be otherwise caused by the scraps B2 contained in the punch 5 can be avoided, it is possible to avoid the interference between the punch 5 and the die 3 although a very small “micro” clearance is set between the punching edge 5b of the punch 5 and the outer circumferential edge of the central portion 3a of the die 3.

In the illustrated embodiment, since the punch 5 has the cylindrical configuration and comprises the outer punching edge 5a for performing the outer circumferential punching work, the inner punching edge 5b for performing the inner circumferential punching work, and the containing space 5c for containing therein a plurality of scraps in a stacked manner, it is possible to perform more exact and better outer and inner circumferential punching works of the sheet material “B”. In addition, since the sheet material “B” is orderly and intermittently fed from the sub-punch 7 to the punch 5, it is possible to perform the continuous punch working of the sheet material “B” in an intermittent manner.

The inventive principles discussed herein can be applied to various kinds of punch working apparatus and methods, especially apparatus in which outer and inner circumferential punching works are simultaneously performed by a punch, a sub-punch aperture is formed in each scrap, and the punch has a scrap containing space.

Certain inventive principles have been described with reference to a preferred example embodiment. Obviously, modifications and alternations will occur to those of ordinary skill in the art upon reading and understanding the preceding detailed description and in applying inventive principles to other apparatus and methods. For example, the configurations of the sub-punch 7, sub-die 4 and the aperture 4a punched by them may be any configuration, such as other than circular. For example, when using a sheet material “B” having a large thickness, the configuration of an aperture formed by the sub-punch may be oval or rectangular in consideration of the metal flow of the sheet material. Also, the configuration of an article may dictate a rectangular annulus. Further, a press can be arranged in other arrangements than the upper/lower arrangement illustrated herein.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A punch working apparatus, comprising a first mold frame on which a die is mounted, a second mold frame movable toward and away from the first mold frame, a punch mounted on the second mold frame, and a sub-punch, the sub-punch adapted for punching an aperture through a sheet material arranged between the first and second mold frames, the punch adapted for simultaneously performing both outer and inner circumferential punching works on the sheet material and containing scraps from punching in a space defined in the punch, wherein the sub-punch is aligned with the punch so that, when the sheet material is advanced after a punching work, an aperture punched by the sub-punch is disposed in a portion of the sheet material that becomes scraps contained in the space of the punch upon punching work of the punch so that scraps received in the space of the punch have the aperture formed therein.

2. The punch working apparatus of claim 1, wherein the punch has a generally cylindrical configuration and comprises an outer punching edge for performing an outer circumferential punching work, an inner punching edge for performing an inner circumferential punching work, and the space for containing therein a plurality of scraps in a stacked manner.

3. The punch working apparatus of claim 2 wherein the sheet material is orderly and intermittently fed from the sub-punch to the punch in regions under them and is simultaneously performed punching works by them when the upper mold frame approaches proximately to the lower mold frame.

4. The punch working apparatus of claim 1 additionally comprising a sheet advancement mechanism for advancing the sheet material through the apparatus, wherein the advancement mechanism is adapted to intermittently advance the sheet material so that an aperture formed by the sub-punch is advanced to align with a portion of the punch so that the aperture is included in a scrap created during punching work of the punch and contained within the space of the punch.

5. A method for performing punch working, comprising providing a punch working apparatus having a first mold frame on which a die is mounted, a second mold frame movable toward and away from the first mold frame, a punch mounted on the second mold frame, and a sub-punch, feeding a sheet material between the first and second mold frames, moving the first and second mold frames toward one another so that the punch and sub-punch perform punch working on the sheet material, the sub-punch adapted to form an aperture through the sheet material, the punch adapted to simultaneously perform both outer and inner circumferential punching works on the sheet material, moving the first and second mold frames away from one another, advancing the sheet material so that an aperture punched in the sheet material by the sub-punch is aligned with the punch, and moving the first and second mold frames toward one another so that the punch performs punch working on the sheet material and generates a scrap, wherein the scrap includes the aperture that was aligned with the punch.

6. The method of claim 5, wherein the punch has a space defined therein, and wherein when the punch performs punch working on the sheet material, the scrap is received into the space.

7. The method of claim 5, wherein the punch has a cylindrical configuration and comprises an outer punching edge for performing an outer circumferential punching work, an inner punching edge for performing an inner circumferential punching work, and the space, wherein the space if configured for containing therein a plurality of scraps in a stacked manner.

8. The method of claim 7, wherein the punch has a space defined therein, and wherein when the punch performs punch working on the sheet material, the scrap is received into the space.
